(19) United States
(12) Patent Application Publication
(10) Pub. No.: US 2011/0233094 A1
(43) Pub. Date: Sep. 29, 2011

(54) HOUSING FOR ELECTRONIC DEVICES AND METHOD FOR MAKING THE SAME

(75) Inventors: KAI-RONG LIAO, Shenzhen City (CN); PENG-CHENG TONG, Shenzhen City (CN); PO-FENG HO, Shindian (TW); SHIH-WEI YANG, Shindian (TW)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/911,839

(22) Filed: Oct. 26, 2010

(30) Foreign Application Priority Data
Mar. 23, 2010 (CN) 201010130438.3

(51) Int. Cl. B65D 85/00; B29C 45/14

(52) U.S. Cl. 206/459.5; 264/250

(57) ABSTRACT

A housing includes a hollow sleeve, a top wall, and a cover. The top wall is integrally formed with the hollow sleeve. The top wall seals an end of the hollow sleeve to define a receiving chamber. An open end is formed at an opposite end of the top wall. The open end communicates with the receiving chamber. The hollow sleeve and the top wall include a transparent first molded article, a decorative layer, and a transparent second molded article. The decorative layer partially is formed on the transparent first molded article, and a transparent display window of the transparent first molded article is exposed from the decorative layer. The transparent second molded article is formed on the decorative layer and the transparent display window. The cover seals the open end. The present disclosure further discloses a method for making the housing.

### CROSS-REFERENCE TO RELATED APPLICATIONS

This application is one of the four related co-pending U.S. patent applications listed below. All listed applications have the same assignee and were concurrently filed herewith. The disclosure of each of the listed applications is incorporated by reference into all the other listed applications.

| Attorney | | |
|---|---|---|
| Docket No. | Title | Inventors |
| US32716 | HOUSING FOR ELECTRONIC DEVICES | Liao et al. |
| | AND METHOD FOR MAKING THE | |
| | SAME | |
| US32837 | HOUSING FOR ELECTRONIC DEVICES | Liao et al. |
| | AND METHOD FOR MAKING THE | |
| | SAME | |
| US32839 | HOUSING FOR ELECTRONIC DEVICES | Liao et al. |
| | AND METHOD FOR MAKING THE | |
| | SAME | |
| US32840 | HOUSING AND ELECTRONIC DEVICE | Liao et al. |
| | USING THE SAME | |

### BACKGROUND

1. Technical Field

The present disclosure relates to housings for electronic devices and method for making the housings.

2. Description of Related Art

Typically, an electronic device housing includes a number of portions. The portions can be assembled together with latching members. However, structures of these housings are complicated due to the latching members, and gaps usually exist at the junctions of the portions. Therefore, dust or other contaminants may easily enter into the housing through these gaps.

Therefore, there is room for improvement within the art.

### BRIEF DESCRIPTION OF THE FIGURES

Many aspects of the housing for electronic devices and method for making the housing can be better understood with reference to the following figures. The components in the figures are not necessarily drawn to scale, the emphasis instead being placed upon clearly illustrating the principles of the housing for electronic devices and method for making the housing. Moreover, in the drawings like reference numerals designate corresponding parts throughout the several views.

FIG. 1 is an exploded view of an exemplary embodiment of a housing.

FIG. 2 is an assembled view of the housing in FIG. 1.

FIG. 3 is a cross-sectional view of the housing in FIG. 2 taken along line III-III.

FIG. 4 is a cross-sectional view of a first mold for manufacturing a first molded article.

FIG. 5 is a cross-sectional view of the first mold shown in FIG. 4, but in a closed state.

FIG. 6 is a cross-sectional view of a moldable plastic injected into the first mold shown in FIG. 5.

### DETAILED DESCRIPTION

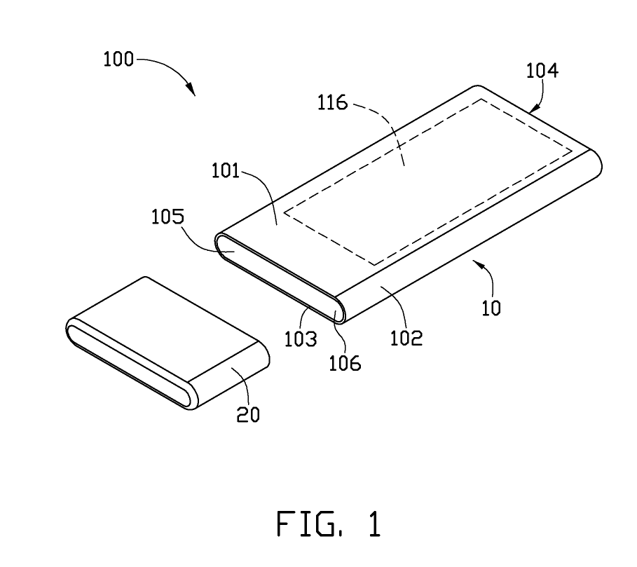

FIG. 1 shows an exemplary housing 100 used in an electronic device, such as a mobile phone, or a personal digital assistant. The housing 100 includes a main body 10 and a cover 20 connecting the main body 10.

The main body 10 may be a hollow sleeve, and includes a first sidewall 101, a second sidewall 103 opposite to the first sidewall 101, two connecting walls 102 connecting the first sidewall 101 to the second sidewall 103, and a top wall 104. The first sidewall 101, the connecting walls 102, the second sidewall 103, and the top wall 104 are integrally formed with each other and cooperatively define a receiving chamber 105 and an open end 106 opening the receiving chamber 105. The receiving chamber 105 receives an electronic module (not shown).

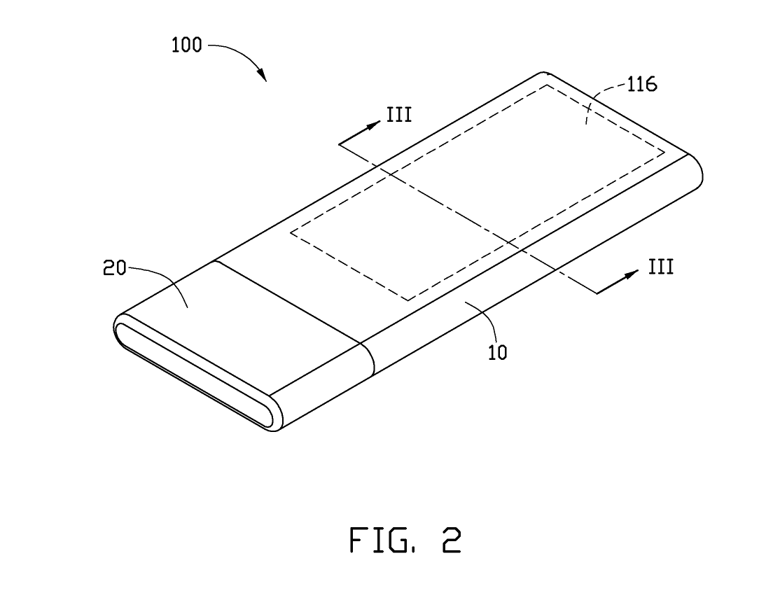

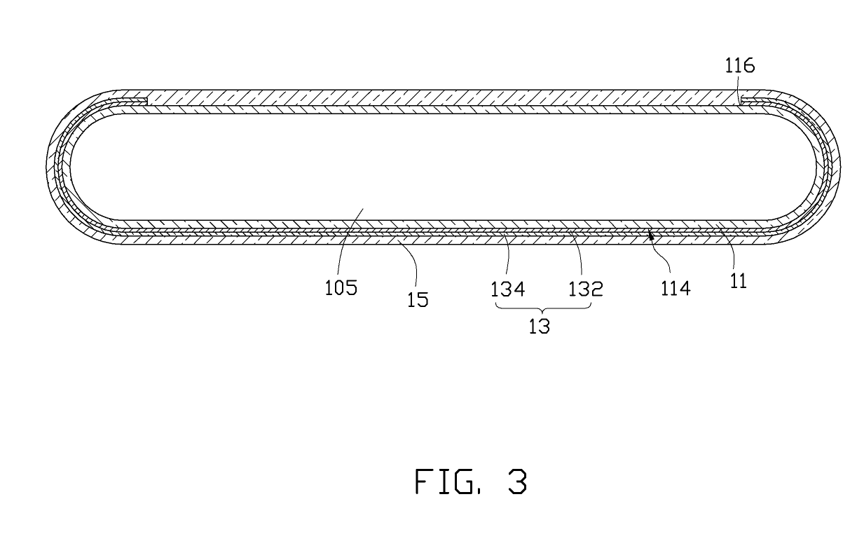

Referring to FIG. 2 and FIG. 3, the main body 10 further includes a first molded article 11, a decorative layer 13, and a second molded article 15. The first molded article 11 may be a hollow sleeve made of a transparent moldable plastic. The transparent moldable plastic may be one or more thermoplastic materials selected from a group consisting of polycarbonate (PC), acrylonitrile-butadiene-styrene (ABS), polymethyl methacrylate (PMMA), butylene terephthalate (PBT), and phenylene sulfide (PPS).

The decorative layer 13 is partially formed on an outer surface 114 of the first molded article 11 to expose a display window 116. The decorative layer 13 is opaque, and includes a colored layer 132 and a transparent protective layer 134 coated on the colored layer 132. The colored layer 132 may be made of ink, paint, or metal coating. The metal coating can be a non-conductive vacuum coating. The transparent protective layer 134 may be made of transparent ink.

The second molded article 15 is formed on the decorative layer 13 and the display window 116. The second molded article 15 may be made of a transparent moldable plastic. The transparent moldable plastic may be one or more thermoplastic materials selected from a group consisting of polycarbonate, acrylonitrile-butadiene-styrene, polymethyl methacrylate), butylene terephthalate, and phenylene sulfide.

The cover 20 may be made of plastic or metal, and seals the open end 106 by adhesive.

An exemplary embodiment of a method for making the housing 100 may include the following steps:

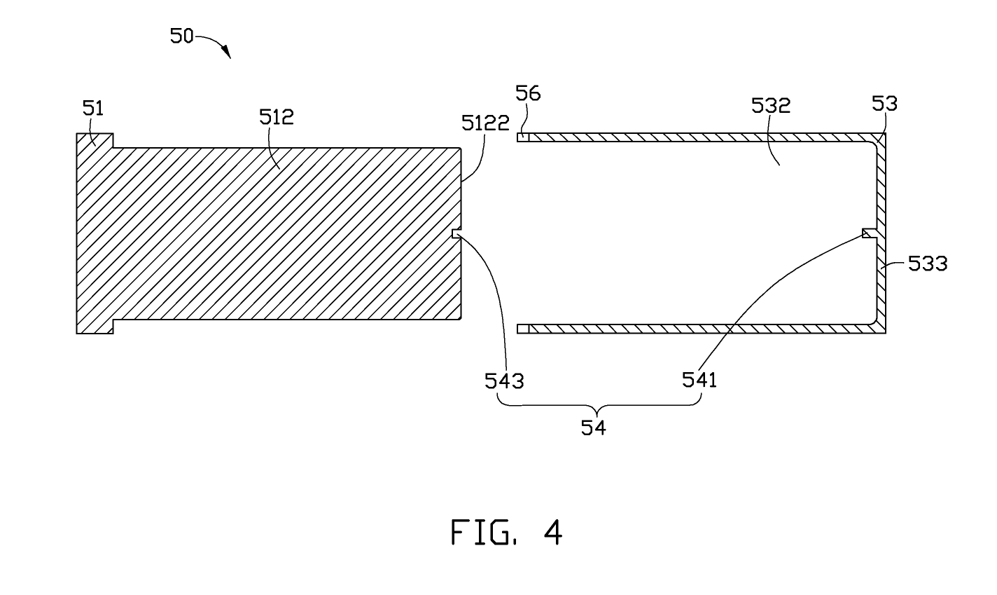

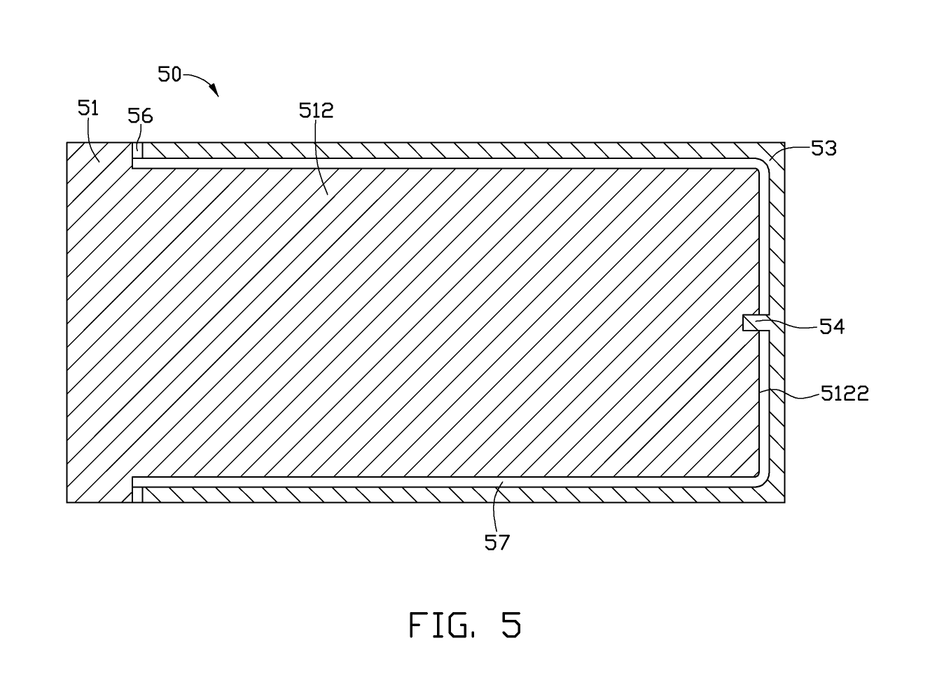

Referring to FIG. 4 and FIG. 5, a first mold 50 is provided. The first mold 50 includes a first core 51, a first cavity 53 matching with the first core 51, and a first positioning mechanism 54. The first core 51 includes a first protrusion 512 protruding therefrom. The first protrusion 512 has a first top portion 5122 facing the first cavity 53.

The first cavity 53 define a first recess 532. When the first mold 50 is closed, the first protrusion 512 is received in the first recess 532 to define a first mold chamber 57. The first positioning mechanism 54 includes a first positioning post 541 and a first hole 543 receiving the first positioning post 541. The first positioning post 541 is mounted on a bottom portion 533 of the first cavity 53 opposing the first top portion 5122. The first hole 543 is defined in the first top portion 5122. The first mold 50 includes at least two first gates 56 defined between the first core 51 and the first cavity 53 when the first mold 50 is closed. When the first mold 50 is closed, the first positioning post 541 is inserted into the first hole 543 to prevent the first protrusion 512 deviating from the first cavity 53.

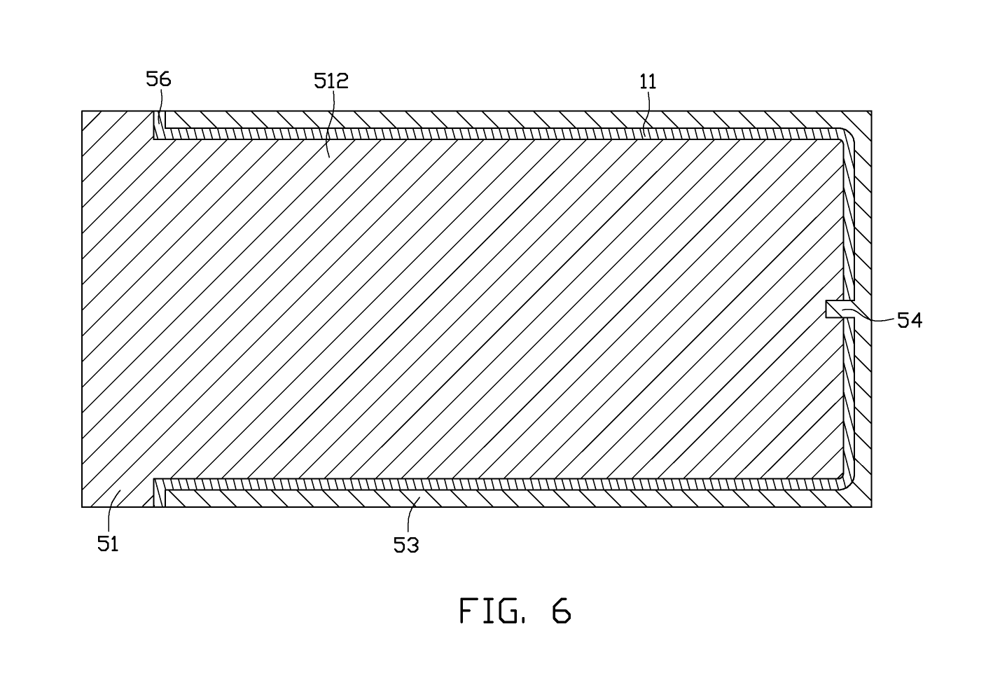

Referring to FIG. 6, the transparent moldable plastic is injected into the first mold chamber 57 from the first gates 56 to form the first molded article 11. After cooled, the first molded article 11 is taken out of the first mole 50. The decorative layer 13 is partially coated on the outer surface 114 of the first molded article 11 to define the display window 116 on the first molded article 11. In the exemplary embodiment, the decorative layer 13 is a non-conductive vacuum coating.

A second mold is provided. The second mold has the same structure as the first mold 50 except for a second mold chamber. The second mold chamber has the same configuration as the main body 10. The first molded article 11 with the decorative layer 13 is placed into the second mold chamber. The transparent moldable plastic is injected into the second mold chamber to form the second molded article 15. The second molded article 15 is combined with the first molded article 11 and the decorative layer 13 to form the main body 10. The decorative layer 13 is sandwiched between the first molded article 11 and the second molded article 15. After cooling, the main body 10 is taken out of the second mold 60. The cover 20 seals the open end 106 by the adhesive to form the housing 100.

In other exemplary embodiment, the first hole 543 can be defined in the first cavity 53. Correspondingly, the first positioning post 541 is mounted on the first top portion 5122.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A housing, comprising:
a main body defining a receiving chamber and an open end communicating with the receiving chamber; the main body comprising:
a transparent first molded article;
a decorative layer partially formed on the transparent first molded article, and a transparent display window exposed from the decorative layer;
a transparent second molded article formed on the decorative layer and the display window; and
a cover sealing the open end.

2. The housing as claimed in claim 1, wherein the main body comprises a first sidewall, a second sidewall opposite to the first sidewall, two connecting walls connecting the first sidewall to the second sidewall, and a top wall; the first sidewall, the second sidewall, the connecting walls, and the top wall cooperatively define the receiving chamber and the open end.

3. The housing as claimed in claim 1, wherein the decorative layer comprises a colored layer made of ink, paint, or metal coating.

4. The housing as claimed in claim 3, wherein the decorative layer comprises a transparent protective layer coated on the colored layer.

5. A housing, comprising:
a hollow sleeve;
a top wall integrally formed with the hollow sleeve, the top wall sealing an end of the hollow sleeve to define a receiving chamber, and an open end formed at an opposite end of the top wall; the open end communicating with the receiving chamber; the hollow sleeve and the top wall comprising
a transparent first molded article;
a decorative layer partially formed on the transparent first molded article, and a transparent display window of the transparent first molded article exposed from the decorative layer;
a transparent second molded article formed on the decorative layer and the transparent display window; and
a cover sealing the open end.

6. The housing as claimed in claim 5, wherein the hollow sleeve comprises a first sidewall, a second sidewall opposite to the first sidewall, two connecting walls connecting the first sidewall to the second sidewall, and the top wall; the first sidewall, the second sidewall, the connecting walls, and the top wall cooperatively define the receiving chamber and the open end.

7. The housing as claimed in claim 5, wherein the decorative layer comprises a colored layer made of ink, paint, or metal coating.

8. The housing as claimed in claim 7, wherein the decorative layer comprises a transparent protective layer coated on the colored layer.

9. A method for making a housing, comprising:
injecting a transparent moldable plastic into a first mold to form a first molded article, the first molded article defining a receiving chamber and an open end communicating with the receiving chamber;
partially coating a decorative layer on the transparent molded article, the transparent molded article exposed from the decorative layer defined a display window;
placing the first molded article and the decorative layer into a second mold and injecting a transparent moldable plastic into the second mold to form a second molded article on the decorative layer and the display window of the first molded article; and
providing a cover sealing the open end.

10. The method for making a housing as claimed in claim 9, wherein the first mold comprises a first core, a first cavity matching with the first core, and a first positioning mechanism, the first positioning mechanism comprises a first positioning post and a first hole receiving the first positioning post; the first core defines the first hole, the first positioning post is mounted on the first cavity.

11. The method for making a housing as claimed in claim 9, wherein the first mold comprises a first core, a first cavity matching with the first core, and a first positioning mechanism, the first positioning mechanism comprises a first positioning post and a first hole receiving the first positioning post; the first cavity defines the first hole, the first positioning post is mounted on the first core.
